(19) United States
(12) Patent Application Publication
(10) Pub. No.: US 2020/0184261 A1
(43) Pub. Date: Jun. 11, 2020

(54) COLLABORATIVE DEEP LEARNING MODEL AUTHORING TOOL

(71) Applicant: International Business Machines Corporation, Armonk, NY (US)

(72) Inventors: Anush Sankaran, Bangalore (IN); Rahul Rajendra Aralikatte, Bangalore (IN); Shreya Khare, Bangalore (IN); Naveen Panwar, Bangalore (IN); Senthil Kumar Kumarasamy Mani, Bangalore (IN); Srikanth Govindaraj Tamilselvam, Chennai (IN)

(21) Appl. No.: 16/210,785

(22) Filed: Dec. 5, 2018

(51) Int. Cl. G06K 9/62; G06N 20/00; H04L 29/06

(52) U.S. Cl. CPC G06K 9/6253; H04L 65/4015; G06N 20/00

(57) ABSTRACT

One embodiment provides a method, including: providing, at a collaborative deep learning model authoring tool, a dialog window that (i) receives user inputs discussing deep learning model aspects and (ii) provides recommendations from the collaborative deep learning model authoring tool; providing, at the collaborative deep learning model authoring tool, a consensus view indicating (i) a conflicting aspect identified as an aspect where more than one user selected a different aspect and (ii) the aspect selected for implementation within the deep learning model based upon that aspect having the most user selections; providing, at the collaborative deep learning model authoring tool, a model view displaying layers of the deep learning model based upon (i) aspects selected by the users in the dialog window and (ii) the aspect selected for implementation in the consensus view; and providing, at the collaborative deep learning model authoring tool, a deployment view that displays an execution of the deep learning model displayed in the model view.

### BACKGROUND

Deep learning models are a type of machine learning model whose training is based upon learning data representations as opposed to task-specific learning. In other words, deep or machine learning is the ability of a computer to learn without being explicitly programmed to perform some function. Thus, machine learning allows a programmer to initially program an algorithm that can be used to predict responses to data, without having to explicitly program every response to every possible scenario that the computer may encounter. In other words, machine learning uses algorithms that the computer uses to learn from and make predictions with regard to data. Machine learning provides a mechanism that allows a programmer to program a computer for computing tasks where design and implementation of a specific algorithm that performs well is difficult or impossible. To implement machine learning, the computer is initially taught using machine learning models from sample inputs. The computer can then learn from the deep learning model in order to make decisions when actual data are introduced to the computer.

### BRIEF SUMMARY

In summary, one aspect of the invention provides a method, comprising: receiving, at a dialog window of a collaborative deep learning model authoring tool, a plurality of user inputs, wherein the user inputs comprise inputs regarding aspects of a deep learning model; providing, within the dialog window, recommendations related to aspects of the deep learning model based upon knowledge of a context of the deep learning model and the user inputs; identifying, at the collaborative deep learning model authoring tool, parameters of the deep learning model to be integrated into the deep learning model by analyzing (i) the user inputs and (ii) additional user inputs provided in response to the recommendations; and displaying, within a model view of the collaborative deep learning model authoring tool, an implementation of the deep learning model having the identified parameters.

Another aspect of the invention provides an apparatus, comprising: at least one processor; and a computer readable storage medium having computer readable program code embodied therewith and executable by the at least one processor, the computer readable program code comprising: computer readable program code configured to receive, at a dialog window of a collaborative deep learning model authoring tool, a plurality of user inputs, wherein the user inputs comprise inputs regarding aspects of a deep learning model; computer readable program code configured to provide, within the dialog window, recommendations related to aspects of the deep learning model based upon knowledge of a context of the deep learning model and the user inputs; computer readable program code configured to identify, at the collaborative deep learning model authoring tool, parameters of the deep learning model to be integrated into the deep learning model by analyzing (i) the user inputs and (ii) additional user inputs provided in response to the recommendations; and computer readable program code configured to display, within a model view of the collaborative deep learning model authoring tool, an implementation of the deep learning model having the identified parameters.

An additional aspect of the invention provides a computer program product, comprising: a computer readable storage medium having computer readable program code embodied therewith, the computer readable program code executable by a processor and comprising: computer readable program code configured to receive, at a dialog window of a collaborative deep learning model authoring tool, a plurality of user inputs, wherein the user inputs comprise inputs regarding aspects of a deep learning model; computer readable program code configured to provide, within the dialog window, recommendations related to aspects of the deep learning model based upon knowledge of a context of the deep learning model and the user inputs; computer readable program code configured to identify, at the collaborative deep learning model authoring tool, parameters of the deep learning model to be integrated into the deep learning model by analyzing (i) the user inputs and (ii) additional user inputs provided in response to the recommendations; and computer readable program code configured to display, within a model view of the collaborative deep learning model authoring tool, an implementation of the deep learning model having the identified parameters.

A further aspect of the invention provides a method, comprising: providing, at a collaborative deep learning model authoring tool, a dialog window that (i) receives user inputs discussing deep learning model aspects and (ii) provides recommendations from the collaborative deep learning model authoring tool; providing, at the collaborative deep learning model authoring tool, a consensus view indicating (i) a conflicting aspect identified as an aspect where more than one user selected a different aspect and (ii) the aspect selected for implementation within the deep learning model based upon that aspect having the most user selections; providing, at the collaborative deep learning model authoring tool, a model view displaying layers of the deep learning model based upon (i) aspects selected by the users in the dialog window and (ii) the aspect selected for implementation in the consensus view; and providing, at the collaborative deep learning model authoring tool, a deployment view that displays an execution of the deep learning model displayed in the model view.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of implementing a deep learning model from a collaborative dialog between designers of a deep learning model and a deep learning model authoring tool.

FIG. 2 illustrates an example of a collaborative deep learning model authoring tool user interface.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

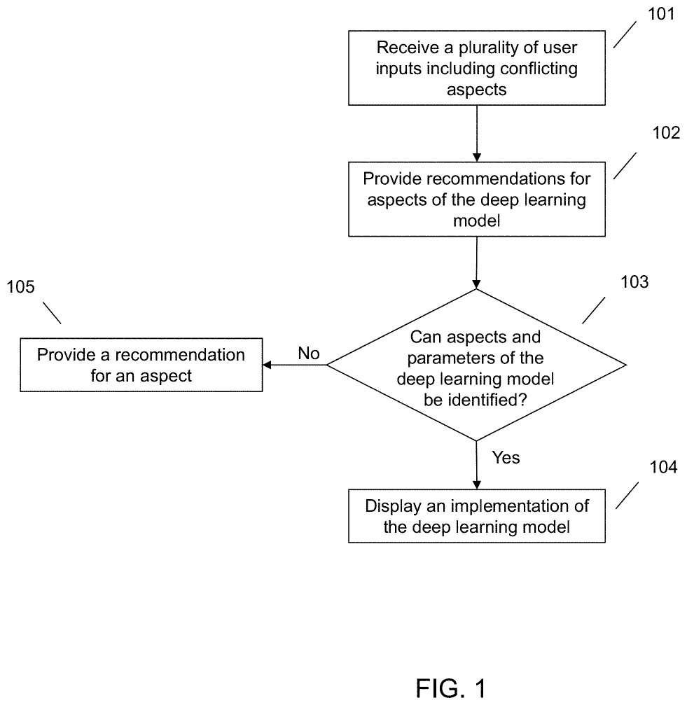

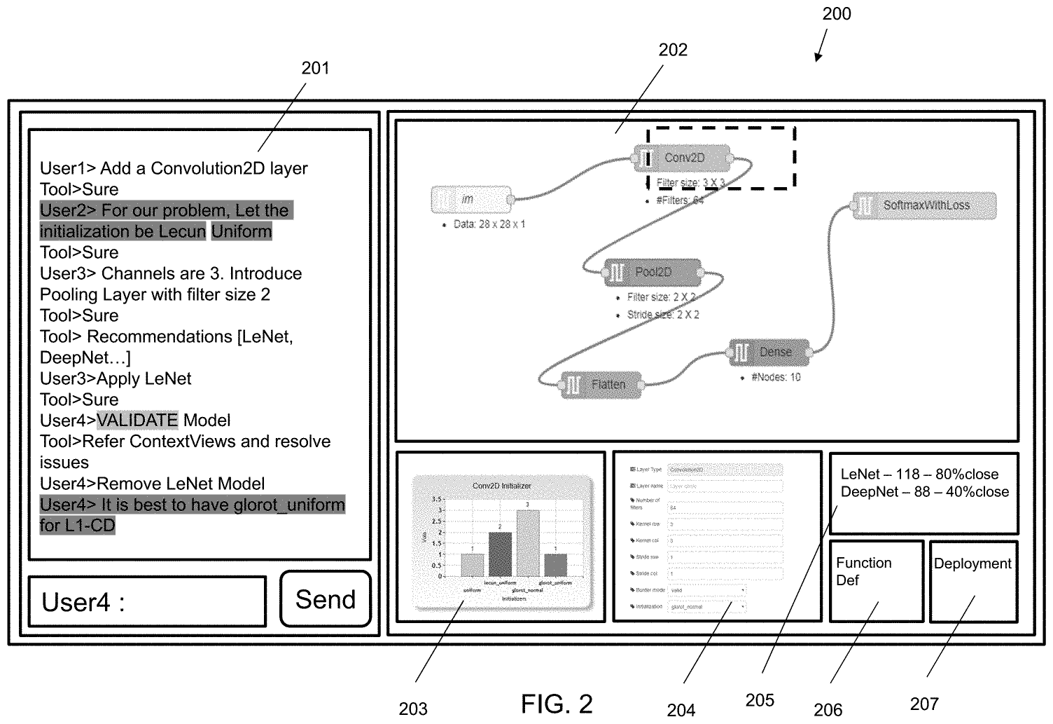

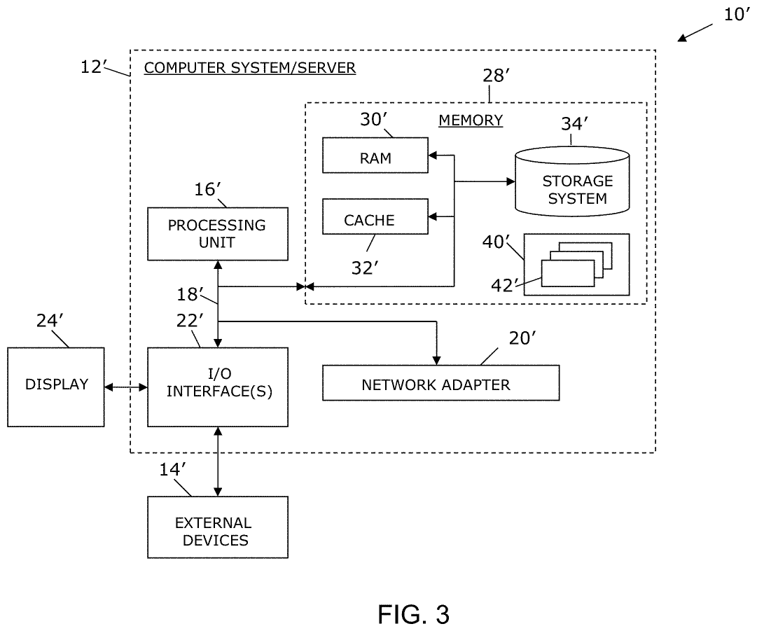

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Deep learning models are generally designed after many collaborations with model designers. The model designers usually discuss the model design in person and using many text-based communications (e.g., email, instant messengers, text messages, etc.). After the designers have decided on the design details and aspects (e.g., parameters, functions, layer sequencing, etc.), one of the designers rebuilds the whole design in a deep learning model authoring tool, for example, a neural effect modeler. The deep learning model authoring tool allows the designer to interact with a user interface and build the deep learning model using a drag and drop user interface to generate and design the multiple deep learning model layers, functions, and parameters.

The problem with this approach is that the designers have multiple design collaborations where notes have to be taken so that the design details can be implemented later. Thus, mistakes may occur because a single user is required to remember what aspects and parameters were decided upon by the design team. Additionally, some design members may have different ideas for aspects and parameters that should be implemented in the deep learning model. Thus, these team members have selected conflicting aspects and parameters which have to be resolved. If the design member responsible for authoring the deep learning model using the authoring tool selects one of these aspects or parameters, not all the team members may be happy with the resulting design. Additionally, a team member may have had a reason for selecting one design aspect or parameter, for example, because it is the only design aspect or parameter that will work with an already selected aspect or parameter, execution of the deep learning model may fail.

Accordingly, an embodiment provides a system and method for implementing a deep learning model from a collaborative dialog between designers of a deep learning model and a deep learning model authoring tool. The collaborative deep learning model authoring tool provides a dialog window that allows the design team members to communicate with each other. Additionally, within the dialog window the tool can provide recommendations for design aspects. Design aspects include layers, hyper-parameter, variables, and the like. A hyper-parameter is a configuration that is external to the model and whose value cannot be estimated from data, and, is therefore, usually set by a developer. The terms hyper-parameter and parameter will be used interchangeably throughout. Accordingly, the system receives, at the dialog window, a plurality of user inputs regarding aspects of a deep learning model. For example, the users may discuss different aspects that should be implemented in the deep learning model as if the users were discussing the design of the deep learning model using a different text-based technique. The tool may provide, in the dialog window, recommendation for aspects based upon a knowledge of the context of a deep learning model and the user input. In other words, since the tool is a deep learning model authoring tool, the tool understands deep learning models, different aspects of such models, and how the models are designed.

From the recommendations and user inputs, the system can identify different parameters of the deep learning model that may be integrated into the deep learning model. Specifically, the tool may analyze the user inputs to identify inputs that correspond to deep learning model parameters. Additionally, the system can use the responses to the recommendations to identify different parameters. Once the parameters are identified, the system can implement the parameters in a deep learning model. The tool provides a view that displays the implementation of the deep learning model having the identified parameters, thereby allowing the designers to view the deep learning model and change parameters that are undesirable. Thus, the described system provides a multi-modal collaborative chat based tool to author deep learning models.

Such a system provides a technical improvement over conventional deep learning model design tools by providing a collaborative deep learning model authoring tool that can receive user inputs that are provided during the collaborative design process. Thus, instead of requiring a user to take notes so that the design can be implemented at a later time, the system is able to be involved in these collaborative sessions. Specifically, the designers can communicate in a dialog window of the collaborative deep learning model authoring tool, and the tool can analyze these user inputs to identify aspects of the deep learning model. Additionally, the tool can provide recommendations for aspects of the deep learning model based upon inputs provided by the users. The tool can also provide a technique for resolving conflicting aspect selections from design team members. Thus, the system provides a more efficient technique for developing a deep learning model. Additionally, the creation of the deep learning model is faster than the conventional method that requires different collaborative sessions external to the authoring tool and a single user implementing the deep learning model using the authoring tool.

FIG. 1 illustrates a method for implementing a deep learning model from a collaborative dialog between designers of a deep learning model and a deep learning model authoring tool. At 101 the collaborative deep learning model authoring tool or system may receive a plurality of user inputs. These user inputs may be provided in a dialog window of the tool. For example, FIG. 2 illustrates an example user interface of the collaborative deep learning model authoring tool. At 201 the system provides a dialog window where multiple users can provide input into the dialog window. These user inputs may include a discussion of different aspects of a deep learning model. For example, one user may identify a particular layer that should be implemented in the deep learning model. The user inputs may also include conflicting aspects, where one user identifies one aspect to be implemented and another user identifies a different, conflicting aspect to be implemented.

Within this dialog window, the tool can also provide outputs that respond to the different users. For example, if a user identifies a particular layer for implementation, the tool can indicate that it has implemented the desired layer. Since the tool understands the context of the dialog, the system is able to identify when other users are responding to other users and provide additional input regarding aspects for the deep learning model. In other words, the system can process different inputs from different users as being correlated to a particular deep learning model aspect or different deep learning model aspects.

Additionally, the system can provide recommendations for aspects within the dialog window at 102. These recommendations are based upon both a knowledge of the context or domain of the deep learning model and the already provided user inputs. In other words, since the tool is specifically designed as a deep learning model authoring tool, the tool knows deep learning model terminology and features. Thus, the tool can understand deep learning model specific text included in the dialog provided by the users. Thus, the system can provide recommendations that are responsive to the user text. For example, as shown in FIG. 2, User3 requests a pooling layer with a particular filter size. In response to this, the tool provides recommendations of different models that fulfill these parameters. The tool is able to provide these recommendations because it understands the deep learning model layers and knows which models would fulfill the parameters. As another example, since a deep learning model includes a plurality of different layers, once one layer is chosen the tool may provide a recommendation for another layer and may recommend a sequence for the layers. In other words, the system not only provides a technique for recommending variables or parameters for the deep learning model, but it can also recommend aspects (e.g., the next layer to be added, an initialization to be used, etc.).

At 103 the system may determine whether aspects of the deep learning model can be identified. To identify the aspects the system analyzes the user inputs and responses to tool inputs and recommendations to determine what aspects and parameters should be implemented in the deep learning model. The identified aspects and parameters may include custom functions or parameter values that are identified by the users within the dialog window. In identifying the aspects, the tool may determine that the dialog includes conflicting aspect inputs. For example, as shown in FIG. 2 within the dialog window, two user inputs are highlighted that provide conflicting aspects. In this example, one user has identified that the initialization be Lecun uniform and another user has identified that the initialization be glorot uniform. However, both of these initializations cannot be implemented in the same deep learning model. Thus, these inputs conflict.

Upon identifying conflicting inputs, the tool may trigger a consensus view that allows the tool to determine which aspect should be implemented. The consensus view may include a consensus gathering view. Within the consensus gathering view the tool may receive inputs or votes from the design team members on which aspect should be selected. The system may then select the aspect that has the highest number of votes or user selections. This value may be the value that is implemented for that particular aspect within the deep learning model. The result of the consensus view is shown at 203. The consensus view 203 may illustrate what aspects values were possible selections and may identify how many users selected a particular aspect.

If the tool cannot identify an aspect or parameter at 103, the system may provide a recommendation for that aspect or parameter at 105. Alternatively, the system may request that the user(s) provide an input for that aspect or parameter. If, however, the tool can identify an aspect or parameter at 103, the system may display an implementation of the deep learning model having parameters fulfilling the identified aspects at 104. The implementation may be displayed within a model view of the authoring tool, for example, as shown at 202. This implementation illustrates the different layers that have been implemented and the parameters that correspond to the layer. The model view also illustrates how the layers are sequenced.

The tool user interface may also provide other views. Another example view includes a context view 204. The context view displays assumptions made, default parameters, inputs, and the like, for a particular layer that has been implemented. In the context view a user can provide inputs modifying a particular parameter of the deep learning model and/or deep learning model layer. In response to this modification, the system may modify the deep learning model using this new parameter. The tool may also provide a recommendation view 205 that displays different recommendations provided by the tool and a closeness of that recommendation to the current deep learning model. The user interface of the tool also provides a function view 206 that allows a user to provide custom functions or parameters for certain parameters of the deep learning model. The tool also provides a deployment view 207 where the implemented deep learning model can be executed and deployed with the identified parameters. Within this view the user can select a layer of the model that results in a display of the parameters of the selected layer in the context view 204.

Thus the described system provides a significant technical improvement to current deep learning model design systems by providing a collaborative deep learning model authoring tool. The deep learning model tool allows for receipt of user inputs in a dialog window that can be used to author the deep learning model. Thus, rather than requiring collaborative sessions and requiring a user to remember the details of these sessions, the system provides the environment for collaboration and is able to generate the deep learning model during these collaborations based upon a knowledge of the domain and context of deep learning models. Additionally, the system can provide aspect recommendations for the deep learning model. The system can also resolve conflicts between conflicting user inputs. Thus, the described system is a more efficient and effective way of authoring deep learning models.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving, at a dialog window of a collaborative deep learning model authoring tool, a plurality of user inputs, wherein the user inputs comprise inputs regarding aspects of a deep learning model;
providing, within the dialog window, recommendations related to aspects of the deep learning model based upon knowledge of a context of the deep learning model and the user inputs;
identifying, at the collaborative deep learning model authoring tool, parameters of the deep learning model to be integrated into the deep learning model by analyzing (i) the user inputs and (ii) additional user inputs provided in response to the recommendations; and
displaying, within a model view of the collaborative deep learning model authoring tool, an implementation of the deep learning model having the identified parameters.

2. The method of claim 1, wherein the identifying comprises determining two or more of the user inputs comprise conflicting aspects.

3. The method of claim 2, comprising selecting one of the aspects from the conflicting aspects, wherein the selecting comprises (i) receiving inputs from each of a plurality of users selecting one of the conflicting aspects and (ii) selecting the aspect having the highest total number of user selections.

4. The method of claim 3, comprising displaying the selections in a consensus view of the collaborative deep learning model authoring tool.

5. The method of claim 1, comprising (i) receiving, within a context view of the collaborative deep learning model authoring tool, user inputs modifying a parameter of the deep learning model, and (ii) modifying, within the model view, the deep learning model based upon the modified parameter.

6. The method of claim 1, wherein the deep learning model comprises a plurality of layers; and
wherein at least one of the recommendations comprises recommending a layer type and sequence of the layer type.

7. The method of claim 1, comprising receiving, in a function view of the collaborative deep learning model authoring tool, a custom parameter for the deep learning model.

8. The method of claim 1, comprising executing, in a deployment view of the collaborative deep learning model authoring tool, the deep learning model having the identified parameters.

9. The method of claim 8, comprising receiving, in the deployment view, a selection of a layer of the deep learning model.

10. The method of claim 9, comprising displaying, in a context view of the collaborative deep learning model authoring tool, the parameters of the selected layer.

11. An apparatus, comprising:
at least one processor; and
a computer readable storage medium having computer readable program code embodied therewith and executable by the at least one processor, the computer readable program code comprising:
computer readable program code configured to receive, at a dialog window of a collaborative deep learning model authoring tool, a plurality of user inputs, wherein the user inputs comprise inputs regarding aspects of a deep learning model;
computer readable program code configured to provide, within the dialog window, recommendations related to aspects of the deep learning model based upon knowledge of a context of the deep learning model and the user inputs;
computer readable program code configured to identify, at the collaborative deep learning model authoring tool, parameters of the deep learning model to be integrated into the deep learning model by analyzing (i) the user inputs and (ii) additional user inputs provided in response to the recommendations; and
computer readable program code configured to display, within a model view of the collaborative deep learning model authoring tool, an implementation of the deep learning model having the identified parameters.

12. A computer program product, comprising:
a computer readable storage medium having computer readable program code embodied therewith, the computer readable program code executable by a processor and comprising:
computer readable program code configured to receive, at a dialog window of a collaborative deep learning model authoring tool, a plurality of user inputs, wherein the user inputs comprise inputs regarding aspects of a deep learning model;
computer readable program code configured to provide, within the dialog window, recommendations related to aspects of the deep learning model based upon knowledge of a context of the deep learning model and the user inputs;
computer readable program code configured to identify, at the collaborative deep learning model authoring tool, parameters of the deep learning model to be integrated into the deep learning model by analyzing (i) the user inputs and (ii) additional user inputs provided in response to the recommendations; and
computer readable program code configured to display, within a model view of the collaborative deep learning model authoring tool, an implementation of the deep learning model having the identified parameters.

13. The computer program product of claim 12, wherein the identifying comprises determining two or more of the user inputs comprise conflicting aspects.

14. The computer program product of claim 13, comprising selecting one of the aspects from the conflicting parameters, wherein the selecting comprises (i) receiving inputs from each of a plurality of users selecting one of the conflicting aspects and (ii) selecting the aspect having the highest total number of user selections; and (iii) displaying the selections in a consensus view of the collaborative deep learning model authoring tool.

15. The computer program product of claim 12, comprising (i) receiving, within a context view of the collaborative deep learning model authoring tool, user inputs modifying a parameter of the deep learning model, and (ii) modifying, within the model view, the deep learning model based upon the modified parameter.

16. The computer program product of claim 12, wherein the deep learning model comprises a plurality of layers; and
wherein at least one of the recommendations comprises recommending a layer type and sequence of the layer type.

17. The computer program product of claim 12, comprising receiving, in a function view of the collaborative deep learning model authoring tool, a custom parameter for the deep learning model.

18. The computer program product of claim 12, comprising executing, in a deployment view of the collaborative deep learning model authoring tool, the deep learning model having the identified parameters.

19. The computer program product of claim 18, comprising receiving, in the deployment view, a selection of a layer of the deep learning model; and
displaying, in a context view of the collaborative deep learning model authoring tool, the parameters of the selected layer.

20. A method, comprising:
providing, at a collaborative deep learning model authoring tool, a dialog window that (i) receives user inputs discussing deep learning model aspects and (ii) provides recommendations from the collaborative deep learning model authoring tool;
providing, at the collaborative deep learning model authoring tool, a consensus view indicating (i) a conflicting aspect identified as an aspect where more than one user selected a different aspect and (ii) the aspect selected for implementation within the deep learning model based upon that aspect having the most user selections;
providing, at the collaborative deep learning model authoring tool, a model view displaying layers of the deep learning model based upon (i) aspects selected by the users in the dialog window and (ii) the aspect selected for implementation in the consensus view; and
providing, at the collaborative deep learning model authoring tool, a deployment view that displays an execution of the deep learning model displayed in the model view.
